(19) United States
(12) Patent Application Publication
(10) Pub. No.: US 2024/0420145 A1
(43) Pub. Date: Dec. 19, 2024

(54) COMPOSITE EVENT SIGNATURE ANALYSIS

(71) Applicant: Wells Fargo Bank, N.A., San Francisco, CA (US)

(72) Inventor: Michael Johnson, Lake Oswego, OR (US)

(21) Appl. No.: 18/334,255

(22) Filed: Jun. 13, 2023

(51) Int. Cl. G06Q 20/40; G06Q 20/38

(52) U.S. Cl. CPC G06Q 20/4016; G06Q 20/3825; G06Q 2220/00

(57) ABSTRACT

In one example, this disclosure describes a method that includes determining a first transaction category identifier based on data for a first financial transaction initiated by a customer. A demographic category identifier is determined based on a set of demographic data associated with the customer. A first composite event signature is established for the customer by combining the transaction category identifier with the demographic category identifier. The customer is assigned to a first profile group of customers having the first composite event signature. A first risk associated with the first profile group is determined, based on zero or more historical fraud events associated with the first profile group. When the first risk exceeds a first threshold, a first fraud report is generated, a first fraud alert is generated, and/or a first mitigation action is performed to mitigate the first risk.

### TECHNICAL FIELD

This disclosure relates to computer networks, and more specifically, to computer networks for fraud identification and/or mitigation.

### BACKGROUND

Financial institutions may monitor customer transactions to determine whether erroneous, fraudulent, illegal, or otherwise improper transactions are taking place. If such transactions are detected, the financial institution may take appropriate action, such as limiting use of one or more accounts associated with the transaction.

### SUMMARY

This disclosure describes techniques for analyzing event data associated with one or more transactions at any of a plurality of financial institutions. The event data includes demographic data for a customer as well as one or more transaction categories. The technical advantages, benefits, improvements, and practical applications of the invention include identifying one or more fraudulent transactions by selectively combining customer demographic data with one or more transaction categories to generate composite event signatures, analyzing the composite event signatures, and generating an alarm in response to the identified one or more fraudulent transactions. The composite event signatures represent a very high volume of transactions with many thousands of potential permutations across multiple customer demographic and transaction categories. In accordance with some embodiments, the transactions are digitized and categorized in order to analyze risk and fraud factors associated with customers in specific categories. The system analyzes the digitized and categorized data to identify patterns in how fraudsters interact with a financial institution in an attempt to gain unauthorized access to third-party accounts.

In some examples, a system comprises a computer-readable memory and one or more processors in communication with the memory. The system determines a first transaction category identifier based on data acquired from a first financial transaction initiated by as customer. The system determines a demographic category identifier based on a set of demographic data associated with the customer. The system establishes a first composite event signature for the customer by combining the transaction category identifier with the demographic category identifier. The system assigns the customer to a first profile group of customers having the first composite event signature. The system determines a first risk associated with the first profile group, based on zero or more historical fraud events associated with the first profile group. When the first risk exceeds a first threshold, the system generates a first fraud report, a first fraud alert, and/or a first mitigation action to mitigate the first risk.

In a further example, the system determines a second transaction category identifier based on data for a second financial transaction initiated by the customer. The system establishes a second composite event signature for the customer by combining the second transaction category identifier with the demographic category identifier. The second financial transaction occurs after the first financial transaction. The system assigns the customer to a second profile group of customers having the second composite event signature. The system determines a second risk associated with the second profile group, based on zero or more historical fraud events associated with the second profile group. When the second risk exceeds the first risk by at least a second threshold, the system generates a second fraud report, a second fraud alert, and/or performs a second mitigation action to mitigate the second risk.

In another example, this disclosure describes methods comprising operations described herein. In yet another example, this disclosure describes a computer-readable storage medium comprising instructions that, when executed, configure processing circuitry of a computing system to carry out operations described herein.

The details of one or more examples of the disclosure are set forth in the accompanying drawings and the description below. Other features, objects, and advantages of the disclosure will be apparent from the description and drawings, and from the claims.

### BRIEF DESCRIPTION OF THE DRAWINGS

FIG. 1 is a block diagram illustrating an example system for establishing and analyzing composite event signatures obtained from financial transaction data, in accordance with one or more aspects of the present disclosure.

FIG. 2 is a block diagram illustrating another example system for establishing and analyzing composite event signatures obtained from financial transaction data, in accordance with one or more aspects of the present disclosure.

FIG. 3 is a flow diagram illustrating a procedure for preparing composite event signatures from transaction data, in accordance with one or more aspects of the present disclosure.

FIG. 4 is a flow diagram illustrating an example process for establishing and analyzing composite event signatures obtained from financial transaction data, in accordance with one or more aspects of the present disclosure.

FIG. 5 is a flow diagram illustrating another example process for establishing and analyzing composite event signatures, in accordance with one or more aspects of the present disclosure.

FIG. 6 is a diagrammatic representation showing an illustrative set of customer cubes, in accordance with one or more aspects of the present disclosure.

FIG. 7 is a data flow diagram showing an illustrative procedure for processing data to generate alerts and reports, in accordance with one or more aspects of the present disclosure.

FIG. 8 is a data flow diagram showing an illustrative procedure for processing data to perform one or more of generating an alert, producing a report, performing an interdiction, or performing an action, in accordance with one or more aspects of the present disclosure.

FIG. 9 is a data flow diagram showing another illustrative procedure for processing data to perform a fraud prevention action comprising one or more of generating an alert, producing a report, performing an interdiction, or performing an action, in accordance with one or more aspects of the present disclosure.

### DETAILED DESCRIPTION

This disclosure describes aspects of a system for establishing and analyzing composite event signatures derived from financial transactions to proactively identify one or more transactions that may be associated with a risk of fraud, and to associate the identified one or more transactions with a notification, a flag, and/or an alarm. In some examples, the system may operate within a single institution, e.g., a single bank, to identify fraud and escalate fraud notifications to multiple member businesses within the institution. In other examples, the system may operate in the context of a cross-entity organization that is external to, and independent of, one or more member institutions. Throughout the disclosure, examples may be described where a computing device and/or a computing system analyzes data associated with one or more events (e.g., financial transactions, wire transfers, interactions with merchants and/or businesses) associated with a computing device and a user of a computing device.

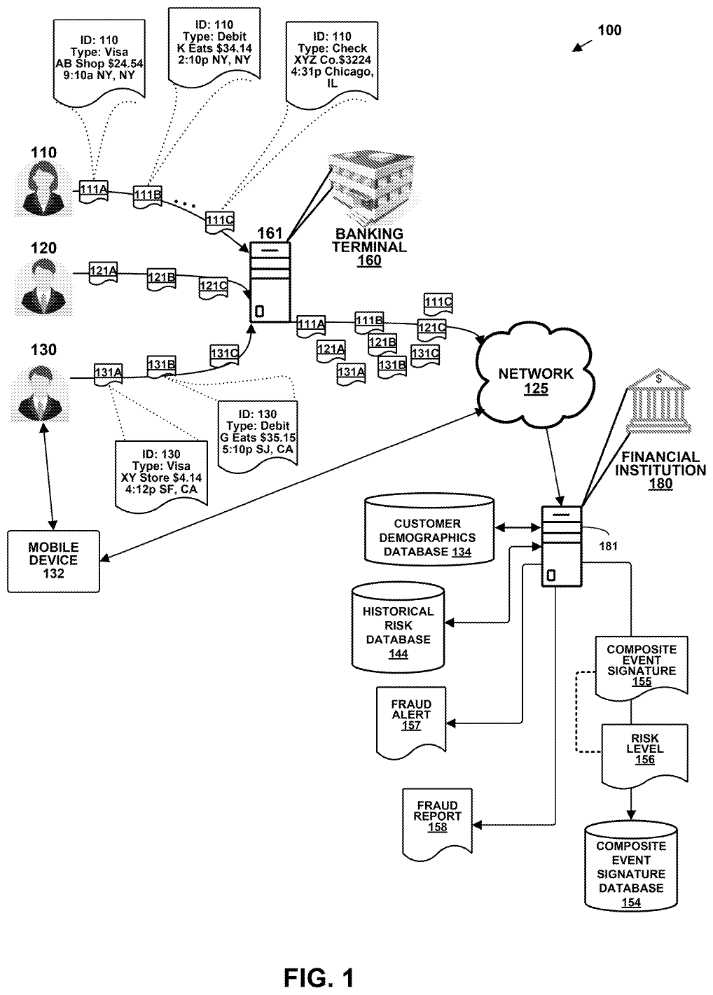

FIG. 1 is a conceptual diagram illustrating a system 100 for establishing and analyzing composite event signatures to proactively identify one or more customer transactions that may be associated with a risk of fraud, in accordance with one or more aspects of the present disclosure. System 100 illustrates a banking terminal 160 associated with a computing system 161. Computing system 161 is configured for gathering data associated with one or more customer transactions from banking terminal 160 and sending the gathered data over a network 125 to a computing system 181 associated with a financial institution 180. In some examples, banking terminal 160 may represent a customer branch of a financial institution, an automated teller machine (ATM), a point-of-sale (POS) terminal, a merchant terminal, a computer equipped with software for sending and/or receiving payments, or another computerized device configured for initiating and/or processing one or more financial transactions. Accordingly, the gathered data may pertain to financial account usage information, transactions data, withdrawals, deposits, balance transfers, balance inquiries, purchases, and/or other financial activity data.

Computing system 181 may receive the gathered data from computing system 161 over network 125. In some examples, network 125 may be the Internet. The data may be analyzed and/or processed by computing system 181. In some examples, financial institution 180 may be an independent entity. In other examples, financial institution 180 may represent an association of multiple financial institutions or a consortium of entities that seek to share some aspects of their data and/or their customers' data to better evaluate, assess, and analyze activities of each of their respective clients and/or account holders. In still other examples, financial institution 180 may be organized as a joint venture or partnership that includes a plurality of financial entities. In some examples, financial institution 180 and banking terminal 160 are operated by the same entity. In other examples, financial institution 180 and banking terminal 160 are operated by different entities.

Banking terminal 160 may be utilized by any of a number of clients, customers, or account holders that maintain one or more accounts with financial institution 180. In the example shown in FIG. 1, three customers 110, 120, and 130 access the banking terminal 160. In some cases, customers 110, 120 and 130 of financial institution 180 may hold multiple accounts at that financial institution. For example, customer 110 may hold one or more credit card accounts, checking accounts, loan or mortgage accounts, brokerage accounts, or other accounts at financial institution 180. Although three individuals in the form of customers 110, 120 and 130 are shown, it should be understood that the techniques described herein may apply in other contexts in which activity or other actions of similarly-situated individuals might be shared, evaluated, and/or analyzed. In some of those situations, such individuals might not be strictly considered “customers” of financial institution 180 or any other entity. However, the techniques described herein are intended to apply to such situations, even for situations in which one or more activities of customers 110, 120, and 130 might not strictly be considered activities of “customers.” Customer 130 may be associated with a mobile device 132. Mobile device 132 may be configured for communicating over network 125, and optionally may be configured for initiating one or more financial transactions with financial institution 180.

As described previously, banking terminal 160 may be associated with computing system 161, and financial institution 180 may be associated with computing system 181. In some embodiments, computing system 161 may be or include a microcontroller that contains one or more central processing unit (CPU) cores, along with program memory and programmable input/output peripherals. Although computing system 161 is shown as a single system, this system is intended to represent any appropriate computing system or collection of computing systems that may be employed by banking terminal 160. Such a computing system may include a distributed, cloud-based data center, or any other appropriate arrangement. Similarly, the computing system 181 may be or include a microcontroller that contains one or more central processing unit (CPU) cores, along with program memory and programmable input/output peripherals. Although computing system 181 is shown as a single system, this system is intended to represent any appropriate computing system or collection of computing systems that may be employed by financial institution 180. Such a computing system may include a distributed, cloud-based data center, or any other appropriate arrangement.

For ease of illustration, only one banking terminal 160, financial institution 180, computing system 161 and computing system 181 are shown in the example of FIG. 1. Techniques described herein may, however, apply to a system involving any number of banking terminals and/or financial institutions, where the banking terminal 160 and/or the financial institution 180 may have any number of computing systems 161 and/or computing systems 181. At least one of computing system 161 or computing system 181 may be used for processing, analyzing, and administering transactions initiated by account holders of financial institution 180 such as any of customers 110, 120 and 130.

Customers 110, 120 and 130 may engage in any of various financial transactions with financial institution 180 using banking terminal 160. Generally, and for ease of illustration, only a limited number of customers 110, 120 and 130 are shown using banking terminal 160. However, in other examples, any number of customers, clients, account holders, or other individuals may use one or more services provided by banking terminal 160. For instance, customer 110 may use a credit card issued by financial institution 180 to purchase an item at a merchant, and then later use that same credit card at a restaurant. Customer 110 may then pay a bill using a checking account she maintains at financial institution 180. Each of these individual transactions represents an event. Each transaction can be represented by a different instance of transaction data 111A, 11B and 11C. Sample data included within each of three instances of transaction data 111A, 111B and 111C is shown in FIG. 1. Such information may include an identity of the customer, which may be a customer account number and/or customer number maintained by at least one of computing system 161 or computing system 181. Information within each instance of transaction data 111A, 111B and 111C may also include any of a type of transaction (e.g., a credit card, debit, credit, check transaction, withdrawal, deposit, balance transfer, or purchase), a name or identity of a payee, an amount of the transaction, a time of the transaction, and/or place at which the transaction took place.

Some illustrative financial transactions initiated by customers 120 and 130 are represented in FIG. 1. For example, customer 120 may engage in a plurality of transactions using a credit card issued by financial institution 180, or using a checking account maintained at financial institution 180. Each of these individual transactions for customer 120 may be represented by an instance of transaction data 121A, 121B and 121C. Customer 130 may perform a plurality of transactions, and these transactions are represented by transaction data 131A, 131B and 131C.

In operation, computing system 161 may receive information about financial transactions initiated by one or more customers. For instance, computing system 161 may receive a series of transaction data 111A, 111B, 111C corresponding to transactions initiated by customer 110. In some examples, computing system 161 may receive transaction data 111A, 111B, 111C over any of a number of different channels. For example, some instances of transaction data 111A may be received by computing system 161 directly from banking terminal 160. Other instances of transaction data 111B may be received by computing system 161 directly from a merchant or other commercial entity (not shown) over network 125. In other cases, one or more instances of transaction data 111C may be received over network 125 through a third party or from a payment processor (not shown). In still other cases, one or more instances of transaction data 111A, 111B, and 111C may be received by computing system 161 over network 125 from customer 110 or from another entity. For each such transaction, computing system 161 and/or computing system 181 processes transaction data 111A, 111B, and 111C and in doing so, performs or prepares to perform appropriate funds transfers, accounting records updates, and balance information updates associated with one or more accounts held by customer 110 at financial institution 180.

Computing system 161 may send transaction data 111A, 111B, 111C, 121A, 121B, 121C, 131A, 131B, and 131C to computing system 181 over network 125. Computing system 181 may receive transaction data 111A, 111B, 111C, 121A, 121B, 121C, 131A, 131B, and 131C from network 125. In some examples, transaction data 111A, 111B, 111C, 121A, 121B, 121C, 131A, 131B, and 131C can be categorized or bucketed into a group by time frame, which may be a daily, weekly, monthly, quarterly, annual, or other time frame. For example, transaction data 111A may be placed into a bucket of data derived from a plurality of credit card transactions taking place during a time period. In other examples, transaction data 111A, 111B, 111C, 121A, 121B, 121C, 131A, 131B, and 131C can be sent to computing system 181 in real time.

Computing system 181 may process transaction data 111A, 111B, 111C, 121A, 121B, 121C, 131A, 131B, and 131C for each of a plurality of respective transactions into a corresponding plurality of composite event signatures (including a composite event signature 155), using data obtained from a customer demographics database 134 for customers 110, 120, and 130. Customer demographics database 134 may associate each of a plurality of customer identifiers with one or more of a customer's age, birthdate, address, zip code, geographic location, estimated income, profession, place of employment, marital status, number of children, credit score, homeowner versus renter, educational level, employment status, bankruptcy status, time with financial institution 180, bank balance at financial institution 180, or any of various other demographic factors.

Composite event signature 155 may be established for customer 110 by combining transaction data 111A pertaining to a financial transaction, with demographic information from customer demographics database 134 pertaining to customer 110. The computing system 181 may associate composite event signature 155 with a corresponding risk level 156 derived from an historical risk database 144. Historical risk database 144 may associate each of a plurality of transaction types and customer demographics with a corresponding level of risk derived from one or more past financial transactions. Computing system 181 may store composite event signature 155 and associated risk level 156 in a composite event signature database 154. In response to an associated risk level 156 being above a threshold, computing system 181 may generate a fraud alert 157, generate a fraud report 158, and/or perform a mitigation action. For example, fraud alert 158 may comprise an electronic communication sent by computing system 181 to network 125 and/or financial institution 180. Fraud report 158 may comprise a textual, graphical, and/or displayed report generated by computing system 181 and forwarded to network 125 and/or financial institution 180 for display and/or printout on a user device. The mitigation action may comprise not completing the financial transaction, reversing the financial transaction, and/or providing a message to a computer device associated with customer 110 over network 125, asking the customer to confirm the transaction.

Computing system 161 and/or computing system 181 may, based on its assessment of each instance of transaction data 111A, 111B and 111C, act on the transaction data. For instance, computing system 161 may use the assessment of transaction data 111A to determine whether to approve or deny the underlying transaction specified by transaction data 111A. If a transaction is approved, computing system 161 and/or computing system 181 may finalize and/or execute any funds transfers and updates made to accounting records and/or balance information associated with accounts held by customer 110 at financial institution 180. If a transaction is denied, computing system 161 and/or computing system 181 may perform fraud mitigation and issue notifications relating to the denied transaction. Such fraud mitigation may include modifications and/or updates to accounting and/or balance information. Notifications relating to the denied transaction may involve computing system 161 sending alerts or other communications to personnel employed by financial institution 180 and/or to an account holder (i.e., customer 110). Such alerts may provide information about the transaction, may seek additional information about the transaction from customer 110, and/or prompt an analysis of the transaction by fraud analysis personnel.

Computing systems 161 and 181 may perform operations described herein using software, hardware, firmware, or a mixture of hardware, software, and firmware residing in and/or executing at one or more computing devices. For example, a computing device may execute such operations using multiple processors or multiple devices. A computing device may execute such operations as a virtual machine executing on underlying hardware. Computing systems 161 and 181 may each include one or more modules that execute as one or more services of an operating system or computing platform. One or more of such modules may execute as one or more executable programs at an application layer of a computing platform. In other examples, functionality provided by a module could be implemented by a dedicated hardware device. The technical advantages, benefits, improvements, and practical applications of the invention include computing system 161 and/or computing system 181 identifying one or more fraudulent transactions by selectively combining customer demographic data with one or more transaction categories to generate composite event signatures, analyzing the composite event signatures, and generating an alarm in response to the identified one or more fraudulent transactions. The composite event signatures represent a very high volume of transactions with many thousands of potential permutations across multiple customer demographic and transaction categories. In accordance with some embodiments, the transactions are digitized and categorized in order to analyze risk and fraud factors associated with customers in specific categories. At least one of computing systems 161 or 181 analyze the digitized and categorized data to identify patterns in how fraudsters interact with a financial institution in an attempt to gain unauthorized access to third-party accounts.

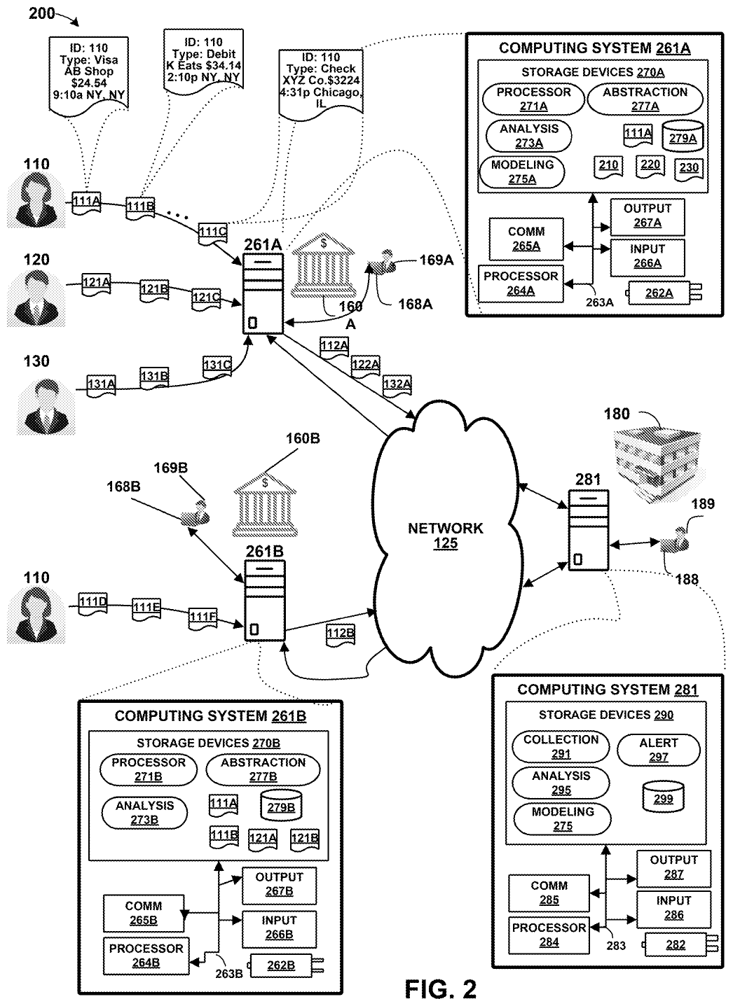

FIG. 2 is a block diagram illustrating another example system for establishing and analyzing composite event signatures obtained from financial transaction data, in accordance with one or more aspects of the present disclosure. FIG. 2 may be described as an example or alternative implementation of system 100 of FIG. 1. In the example of FIG. 2, system 200 includes many of the same elements described in FIG. 1, and elements illustrated in FIG. 2 may correspond to earlier-illustrated elements that are identified by like-numbered reference numerals. In general, such like-numbered elements may represent previously-described elements in a manner consistent with prior descriptions, although in some examples, such elements may be implemented differently or involve alternative implementations with more, fewer, and/or different capabilities and/or attributes. One or more aspects of FIG. 2 may be described herein within the context of FIG. 1.

Computing system 281, illustrated in FIG. 2, may correspond to computing system 181 of FIG. 1. Similarly, computing system 261A and computing system 261B (collectively, “computing systems 261”) may correspond to earlier-illustrated computing system 161. These devices, systems, and/or components may be implemented in a manner consistent with the description of the corresponding system provided in connection with FIG. 1, although in some examples such systems may involve alternative implementations with more, fewer, and/or different capabilities. For ease of illustration, only computing system 261A and computing system 261B are shown in FIG. 2. However, any number of computing systems 261 may be included within system 200, and techniques described herein may apply to a system having any number of computing systems 261 or computing systems 281.

Each of computing system 281, computing system 261A, and computing system 261B may be implemented as any suitable computing system, such as one or more server computers, workstations, mainframes, appliances, cloud computing systems, and/or other computing systems that may be capable of performing operations and/or functions described in accordance with one or more aspects of the present disclosure. In some examples, any of computing systems 281, 261A, and/or 261B may represent a cloud computing system, server farm, and/or server cluster (or portion thereof) that provides services to client devices and other devices or systems. In other examples, such systems may represent or be implemented through one or more virtualized compute instances (e.g., virtual machines, containers) of a data center, cloud computing system, server farm, and/or server cluster.

In the example of FIG. 2, computing system 281 may include power source 282, one or more processors 284, one or more communication units 285, one or more input devices 286, one or more output devices 287, and one or more storage devices 290. Storage devices 290 may include modeling module 275, collection module 291, analysis module 295, alert module 297, and data store 299. Data store 299 may store various data described elsewhere herein, including, for example, transaction data 111A, 111B, 111C, 111D, 111E, and/or 111F.

Power source 282 may provide power to one or more components of computing system 281. Power source 282 may receive power from the primary alternating current (AC) power supply in a building, home, or other location. In other examples, power source 282 may be a battery or a device that supplies direct current (DC). In still further examples, computing system 281 and/or power source 282 may receive power from another source. One or more of the devices or components illustrated within computing system 281 may be connected to power source 282, and/or may receive power from power source 282. Power source 282 may have intelligent power management or consumption capabilities, and such features may be controlled, accessed, or adjusted by one or more modules of computing system 281 and/or by one or more processors 284 to intelligently consume, allocate, supply, or otherwise manage power.

One or more processors 284 of computing system 281 may implement functionality and/or execute instructions associated with computing system 281 or associated with one or more modules illustrated herein and/or described below. One or more processors 284 may be, may be part of, and/or may include processing circuitry that performs operations in accordance with one or more aspects of the present disclosure. Examples of processors 284 include microprocessors, application processors, display controllers, auxiliary processors, one or more sensor hubs, and any other hardware configured to function as a processor, a processing unit, or a processing device. Computing system 281 may use one or more processors 284 to perform operations in accordance with one or more aspects of the present disclosure using software, hardware, firmware, or a mixture of hardware, software, and firmware residing in and/or executing at computing system 281.

One or more communication units 285 of computing system 281 may communicate with devices external to computing system 281 by transmitting and/or receiving data, and may operate, in some respects, as both an input device and an output device. In some examples, communication units 285 may communicate with other devices over a network. In other examples, communication units 285 may send and/or receive radio signals on a radio network such as a cellular radio network. In other examples, communication units 285 of computing system 281 may transmit and/or receive satellite signals on a satellite network such as a Global Positioning System (GPS) network.

One or more input devices 286 may represent any input devices of computing system 281 not otherwise separately described herein. One or more input devices 286 may generate, receive, and/or process input from any type of device capable of detecting input from a human or machine. For example, one or more input devices 286 may generate, receive, and/or process input in the form of electrical, physical, audio, image, and/or visual input (e.g., peripheral device, keyboard, microphone, camera, or the like).

One or more output devices 287 may represent any output devices of computing systems 281 not otherwise separately described herein. One or more output devices 287 may generate, receive, and/or process output from any type of device capable of outputting information to a human or machine. For example, one or more output devices 287 may generate, receive, and/or process output in the form of electrical and/or physical output (e.g., peripheral device, actuator).

One or more storage devices 290 within computing system 281 may store information for processing during operation of computing system 281. Storage devices 290 may store program instructions and/or data associated with one or more of the modules described in accordance with one or more aspects of this disclosure. One or more processors 284 and one or more storage devices 290 may provide an operating environment or platform for such modules, which may be implemented as software, but may in some examples include any combination of hardware, firmware, and software. One or more processors 284 may execute instructions and one or more storage devices 290 may store instructions and/or data of one or more modules. The combination of processors 284 and storage devices 290 may retrieve, store, and/or execute the instructions and/or data of one or more applications, modules, or software. Processors 284 and/or storage devices 290 may also be operably coupled to one or more other software and/or hardware components, including, but not limited to, one or more of the components of computing system 281 and/or one or more devices or systems illustrated as being connected to computing system 281.

In some examples, one or more storage devices 290 are temporary memories, which may mean that a primary purpose of the one or more storage devices is not long-term storage. Storage devices 290 of computing system 281 may be configured for short-term storage of information as volatile memory and therefore not retain stored contents if deactivated. Examples of volatile memories include random access memories (RAM), dynamic random access memories (DRAM), static random access memories (SRAM), and other forms of volatile memories known in the art. Storage devices 290, in some examples, also include one or more computer-readable storage media. Storage devices 290 may be configured to store larger amounts of information than volatile memory. Storage devices 290 may further be configured for long-term storage of information as non-volatile memory space and retain information after activate/off cycles. Examples of non-volatile memories include magnetic hard disks, optical discs, Flash memories, or forms of electrically programmable memories (EPROM) or electrically erasable and programmable (EEPROM) memories.

In operation, computing systems 261A and/or 261B may receive information about financial transactions initiated by one or more customers. For instance, computing system 261A may receive a series of transaction data 111A, 111B, 111C corresponding to transactions initiated by customer 110. Likewise, computing system 261B may receive a series of transaction data 111D, 111E, and 111F corresponding to transactions initiated by customer 110. In some examples, computing system 261A may receive transaction data 111A-111F over any of a number of different channels. For example, some instances of transaction data 111A-111F may be received by computing systems 261A or 261B directly from banking terminal 160A or 160B, respectively. Other instances of transaction data 111A-111F may be received by computing systems 261A or 261B directly from a merchant or other commercial entity (not shown) over network 125. In other cases, one or more instances of transaction data 111A-111F may be received over network 125 through a third party or from a payment processor (not shown). In still other cases, one or more instances of transaction data 111A-111F may be received by computing systems 261A or 261B over network 125 from customer 110 or from another entity. For each such transaction, computing systems 261A, 261B and/or 281 process transaction data 111A-111F and in doing so, perform or prepare to perform appropriate funds transfers, accounting records updates, and balance information updates associated with one or more accounts held by customer 110 at financial institution 180.

Computing system 261A may store transaction data 111A-111F associated with customer 110. For instance, communication unit 265A of computing system 261A detects a signal over network 125. Communication unit 265A outputs information about the signal to transaction processing module 271A. Transaction processing module 271A determines that the signal includes information about a transaction performed on an account held by customer 110 at an entity associated with banking terminal 160A. In some examples, the information includes details about a financial transaction, such as a merchant name or identifier, a transaction amount, time, and/or location. Transaction processing module 271A stores information about the transaction in data store 279A (e.g., as transaction data 111A). Computing system 261A may receive additional instances of transaction data 111B-111F associated with transactions performed on accounts held by customer 110 at an entity associated with banking terminal 160A, and each such instance may be similarly processed by transaction processing module 271A and stored as an instance of transaction data 111A-111F in data store 279A.

Computing system 261A may store information about transactions performed by other customers. For instance, still referring to FIG. 2, communication unit 265A of computing system 261A again detects a signal over a network, and outputs information about the input to transaction processing module 271A. Transaction processing module 271A determines that the signal includes information about a transaction performed by another client, customer, or account holder at an entity associated with banking terminal 160A, such as customer 120. Transaction processing module 271A stores the information about the transaction in data store 279A (e.g., as transaction data 121A, 121B and 121C). Transaction processing module 271A may also receive additional instances of transaction data corresponding to other transactions performed on accounts held at entity associated with banking terminal 160A by customer 120. Each time, transaction processing module 271A stores such instances of transaction data as transaction data 121A, 121B and 121C in data store 279A. In general, transaction processing module 271A may receive a series of transaction information associated with transactions performed on accounts held by any number of customers of entity associated with banking terminal 160A (e.g., customers 110, 120, 130, etc.), and in each case, transaction processing module 271A of computing system 261A may process such information and store a corresponding instance of transaction data.

Computing system 261B, also illustrated in FIG. 2, may operate similarly. For instance, transaction processing module 271B of computing system 261B may receive a series of transaction information associated with accounts held by customers of the entity associated with banking terminal 160B. Transaction processing module 271B may process such information and store a corresponding instance of transaction data in data store 279B.

Computing systems 261A and 261B may send transaction data 111A-111F, 121A, 121B, 121C, 131A, 131B, and 131C to computing system 281 over network 125. Computing system 281 may receive transaction data 111A-111F, 121A, 121B, 121C, 131A, 131B, and 131C from network 125. In some examples, transaction data 111A-111F, 121A, 121B, 121C, 131A, 131B, and 131C can be categorized or bucketed into a group by time frame, which may be a daily, weekly, monthly, quarterly, annual, or other time frame. For example, transaction data 111A may be placed into a bucket of data derived from a plurality of credit card transactions taking place during a time period. In other examples, transaction data 111A-111F, 121A, 121B, 121C, 131A, 131B, and 131C can be sent to computing system 281 in real time.

Computing system 281 may process transaction data 111A-111F, 121A, 121B, 121C, 131A, 131B, and 131C for each of a plurality of respective transactions into a corresponding plurality of composite event signatures, using data obtained from a customer demographics database stored in storage device 290 for customers 110, 120, and 130. The customer demographics database may associate each of a plurality of customer identifiers with one or more of a customer's age, birthdate, address, zip code, geographic location, estimated income, profession, place of employment, marital status, number of children, credit score, homeowner versus renter, educational level, employment status, bankruptcy status, time with financial institution 180, bank balance at financial institution 180, or any of various other demographic factors.

Computing system 281 may establish the composite event signature for customer 110 by combining transaction data 111A pertaining to a financial transaction, with demographic information from the customer demographics database pertaining to customer 110. The computing system 281 may associate the composite event signature with a corresponding risk level derived from an historical risk database in storage device 290. The historical risk database may associate each of a plurality of transaction types and customer demographics with a corresponding level of risk derived from one or more past financial transactions. Computing system 281 may store the composite event signature and associated risk level in a composite event signature database stored in storage device 290.

Collection module 291 may perform functions relating to receiving instances of transaction data from one or more of computing systems 261, and to the extent such information is stored, storing information into data store 299. In some examples, collection module 291 may access data store 279A of computing system 261A over network 125, and/or data store 279B of computing system 261B over network 125, to retrieve various instances of transaction data. Collection module 291 may expose an API (application programming interface) that one or more of computing systems 261 engage to upload instances of transaction data. In some examples, collection module 291 may specify and/or define the form in which instances of transaction data should be uploaded, and at least in that sense, computing system 281 may define or mandate the disclosure of certain attributed or abstracted transaction data received from computing systems 261, and/or may define or mandate the format in which such data is transmitted by each of computing systems 261.

Analysis module 295 may receive instances of transaction data from collection module 291. Additionally, analysis module 295 may receive information from modeling module 275 about models developed by modeling module 275. Moreover, analysis module 295 may receive one or more composite event signatures from the composite event signature database stored in storage device 290. Modeling module 275 may perform modeling functions, which may include training, evaluating, and/or applying models (e.g., machine learning models) to evaluate and/or analyze transactions, customer behavior, or other aspects of customer activity. Such models can incorporate one or more composite event signatures. Such models may have been developed by modeling module 275 to assess risk and/or to make fraud assessments for accounts held by customers at the entity associated with banking terminals 160A and 160B. In some examples, modeling module 275 may train and/or continually retrain a machine learning model to make fraud and other assessments for transactions occurring on any of the accounts at the entity associated with banking terminals 160A and 160B, in response to one or more composite event signatures. For instance, modeling module 275 may develop a model of behavior associated with one or more customers 110, 120, and/or 130, according to one or more composite event signatures associated with customers 110, 120, and/or 130. Such a model may enable computing system 281 (or analysis module 295) to determine when transactions might be unusual, erroneous, fraudulent, or otherwise improper, based on the one or more composite event signatures. Analysis module 295 may organize the information about models, which may include outputs or conclusions reached by the models, but could also include parameters, composite event signatures, and/or data associated underlying or used to develop such models.

Analysis module 295 may communicate with modeling module 275 to perform functions relating to analyzing instances of transaction data received from one or more of computing systems 261 and gathered by collection module 291 to determine whether such data has any markers or indicia indicating fraudulent, illegitimate, erroneous, or otherwise problematic transactions. In some examples, analysis module 295 may perform an analysis in the context of composite event signatures, transaction velocity, transaction repletion, transaction type repetition, device type used to perform the transactions, and/or the locations at which transactions were performed. In some examples, analysis module 295 may perform an analysis by considering transactions occurring on accounts across a single entity that is associated with, and/or that operates, banking terminals 160A and 160B. The single entity may be a financial institution. In other examples, analysis module 295 and/or modeling module may perform an analysis by considering transactions occurring on accounts across multiple entities.

In some examples, modeling module 275 may apply one or more models incorporating composite event signatures to the transaction data associated with accounts maintained by customers using banking terminals 160A and 160B. Analysis module 295 may perform an assessment of any of the transaction data associated with accounts maintained by the entity associated with banking terminals 160A and 160B. Analysis module 295 may perform such an assessment by applying transaction data received from each banking terminal 160A and 160B to one or more models received from modeling module 275, wherein the one or more models incorporate composite event signatures. Such models may determine whether the transaction data is consistent with past spending and/or financial activity practices associated with a given customer (e.g., any of customers 110, 120, and/or 130). In other words, analysis module 295 may use composite event signatures to determine whether transactions performed by a specific customer is considered “normal” or is in one or more ways inconsistent with prior activities performed by each such customer. For example, analysis module 295 may apply a model from modeling module 275 to abstracted transaction data 112A and abstracted transaction data 112B to make an assessment of accounts held by customer 110 at the entity associated with banking terminals 160A and 160B.

In some examples, analysis module 295 may use composite event signatures to generate a score for customer 110 (or other customers) that quantifies the activity of such customers relative to normal. In one example, analysis module 295 might generate a set of categories or range of values for each such customer, quantifying the activity of each such customer. Categories might range from green (normal) to yellow (a little unusual) to red (abnormal), whereas a score might range from 0 (normal) to 100 (abnormal). In some examples, a model used by computing system 281 may use human input (e.g., through analyst computing system 188, operated by analyst 189) to help assess whether a given set of activity is normal, unusual, or abnormal.

In general, analysis module 295 may evaluate transaction data associated with each of a plurality of customers using composite event signatures. Alert module 297 may perform functions relating to reporting information, including alerts associated with one or more fraudulent transactions, to one or more computing systems 261 over network 125. Analysis module 295 may cause alert module 297 to act on assessments performed by analysis module 295 using modeling module 275. These assessments may be acted upon by causing computing systems 261 to limiting use of one or more accounts at the entity associated with banking terminals 160A and 160B, and/or issuing alerts and/or notifications. In some examples, the issued alerts and/or notifications are sent to one or more computing systems, such as an analyst computing system 168A used by an analyst 169A, and/or an analyst computing system 168B used by an analyst 169B. In some examples, the issued alerts and/or notifications are sent to customers of the entity associated with banking terminals 160A and 160B.

One or more of computing systems 261 may act on information received from computing system 281. For instance, by evaluating one or more composite event signatures, analysis module 295 may determine, based on its own analysis and/or that of a model from modeling module 275, that one or more of the transactions performed on an account held by customer 110 is (or are likely to be) fraudulent, illegitimate, erroneous, or otherwise improper. Analysis module 295 outputs information to alert module 297. Alert module 297 causes communication unit 285 to output a signal over a network destined to computing system 261A. Communication unit 265A of computing system 261A detects a signal over the network. Communication unit 265A outputs information about the signal to analysis module 272A. Analysis module 272A determines, based on the information, that fraud is likely occurring on accounts held by customer 110 (i.e., either at entity 160A or at a different entity 160). Analysis module 272A takes action to prevent improper transactions at entity 160A. Analysis module 272A may, for example, cease processing transactions for accounts associated with customer 110 for certain products (e.g., credit cards, wire transfers).

In some examples, computing systems 261A, 261B and/or 281 may, based on the assessment of each instance of transaction data 111A-111F by analysis module 295, act on the transaction data. For instance, computing system 261A may use the assessment of transaction data 111A to determine whether to approve or deny the underlying transaction specified by transaction data 111A. If a transaction is approved, computing system 261A and/or computing system 281 may finalize and/or execute any funds transfers and updates made to accounting records and/or balance information associated with accounts held by customer 110 at financial institution 180. If a transaction is denied, computing system 261A and/or computing system 281 may perform fraud mitigation and issue notifications relating to the denied transaction. Such fraud mitigation may include modifications and/or updates to accounting and/or balance information. Notifications relating to the denied transaction may involve computing system 261A sending alerts or other communications to personnel employed by financial institution 180 and/or to an account holder (i.e., customer 110). Such alerts may provide information about the transaction, may seek additional information about the transaction from customer 110, and/or prompt an analysis of the transaction by fraud analysis personnel.

In some examples, in response to an associated risk level being above a threshold, alert module 297 of computing system 281 may generate a fraud alert, generate a fraud report, and/or perform a mitigation action. For example, the fraud alert may comprise an electronic communication sent by computing system 281 to network 125 and/or financial institution 180. The fraud report may comprise a textual, graphical, and/or displayed report generated by computing system 281 and forwarded to network 125 and/or financial institution 180 for display and/or printout on a user device. The mitigation action may comprise not completing the financial transaction, reversing the financial transaction, and/or providing a message to a computer device associated with customer 110 over network 125, asking the customer to confirm the transaction.

In some examples, computing system 281 may communicate with computing system 261B, providing information suggesting fraud may be occurring on accounts held by customer 110. Computing system 261B may, in response, also take action to prevent improper transactions (or further improper transactions) on accounts held by customer 110 at the entity associated with banking terminal 160B. Such actions may involve suspending operations of credit cards or other financial products for accounts held by customer 110, or limiting such use.

In some examples, computing system 281 may additionally notify an analyst of potential fraud. For instance, in response to determining that transactions performed on an account held by customer 110 may be improper, analysis module 295 may cause communication unit 285 to output a signal over a network to analyst computing system 188. Analyst computing system 188 detects a signal and in response, generates a user interface presenting information identifying the potentially fraudulent, illegitimate, or erroneous transactions occurring on an account held by customer 110. Analyst computing system 188 may detect interactions with the user interface, reflecting input by analyst 189. In some cases, analyst computing system 188 may interpret such input as an indication to override fraud assessment. In such an example, analyst computing system 188 may interact with computing system 281, computing system 261A, and/or computing system 261B to prevent or halt the cessation of transaction processing associated with accounts held by customer 110. In other cases, however, analyst computing system 188 may interpret input by analyst 189 as not overriding the fraud assessment, in which case computing system 261A and/or computing system 261B may continue with fraud mitigation operations.

In some examples, computing system 281 may alternatively, or in addition, communicate with analyst computing system 168A and/or analyst computing system 168B about potential fraud. For instance, computing system 281 may communicate information to analyst computing system 168A and analyst computing system 168B. Each of analyst computing systems 168A and 168B may use such information to generate a user interface presenting information about potential fraud associated with accounts held by customer 110. Analyst computing system 168A may detect interactions with the user interface it presents, reflecting input by analyst 169A. Analyst computing system 168A may interpret such input as an indication to either override or not override the fraud assessment, and in response, analyst computing system 168A may act accordingly (e.g., enabling computing system 261A to mitigate fraud). Similarly, analyst computing system 168B may detect interactions with the user interface it presents, reflecting input by analyst 169B. Analyst computing system 168B may interpret such input as an indication to either override or not override the fraud assessment, and analyst computing system 168B may act accordingly. Since computing system 261A and computing system 261B may receive different data from computing system 281, and since each of analyst 169A and analyst 169B may make different assessments of the data each evaluates, computing system 261A and computing system 261B may respond to communications from computing system 281 differently.

In some examples, computing system 281 may notify customers of potential fraud. For instance, computing system 281 may cause communication unit 285 to output a signal over a network that causes a notification to be presented to a computing device (e.g., mobile device) used by customer 110. Such a notification may indicate that transactions processing has been limited or stopped for certain accounts held by customer 110. The notification may invite customer 110 to participate in a conversation or other interaction with personnel employed by the entity associated with banking terminals 160A and 160B about the potentially improper transactions.

The above examples outline operations taken by computing system 281, computing system 261A, and/or computing system 261B in scenarios in which transactions occurring on accounts held by customer 110 may appear improper. Similar operations may also be performed to the extent that transactions occurring on accounts held by other customers may appear improper. In such cases, computing system 281, computing system 261A, computing system 261B, and/or other systems may take actions similar to those described herein.

In the example of FIG. 2, data store 299 may represent any suitable data structure or storage medium for storing transaction data. The information stored in data store 299 may be searchable and/or categorized such that one or more modules within computing system 281 may provide an input requesting information from data store 299, and in response to the input, receive information stored within data store 299. In some examples, data store 299 may be primarily maintained by collection module 291.

Computing system 261A may include power source 262A, one or more processors 264A, one or more communication units 265A, one or more input devices 266A, one or more output devices 267A, and one or more storage devices 270A. Storage devices 270A may include transaction processing module 271A, analysis module 273A, abstraction module 277A, and data store 279A. Data store 279A may store data described herein, including, for example, various instances of transaction data and abstracted transaction data. Similarly, computing system 261B may include power source 262B, one or more processors 264B, one or more communication units 265B, one or more input devices 266B, one or more output devices 267B, and one or more storage devices 270B.

Certain aspects of computing systems 261 are described below with respect to computing system 261A. For example, power source 262A may provide power to one or more components of computing system 261A. One or more processors 264A of computing system 261A may implement functionality and/or execute instructions associated with computing system 261A or associated with one or more modules illustrated herein and/or described below. One or more communication units 265A of computing system 261A may communicate with devices external to computing system 261A by transmitting and/or receiving data over a network or otherwise. One or more input devices 266A may represent any input devices of computing system 261A not otherwise separately described herein. Input devices 266A may generate, receive, and/or process input, and output devices 267A may represent any output devices of computing system 261A. One or more storage devices 270A within computing system 261A may store program instructions and/or data associated with one or more of the modules of storage devices 270A in accordance with one or more aspects of this disclosure. Each of these components, devices, and/or modules may be implemented in a manner similar to or consistent with the description of other components or elements described herein.

Transaction processing module 271A may perform functions relating to processing transactions performed by one or more of customers using accounts held at one or more of entities, such as an entity that is associated with and/or operates banking terminals 160A and 160B. Analysis module 273A (FIG. 2) may perform functions relating to analyzing transaction data and determining whether one or more underlying transactions has signs of fraud or other issues. Abstraction module 277A may perform functions relating to processing transaction data to remove personally-identifiable data and/or other data having privacy implications. Data store 279A is a data store for storing various instances of data generated and/or processed by other modules of computing system 261A.

Descriptions herein with respect to computing system 261A may correspondingly apply to one or more other computing systems 261. Other computing systems 261 (e.g., computing system 261B and others, not shown) may therefore be considered to be described in a manner similar to that of computing system 261A, and may also include the same, similar, or corresponding components, devices, modules, functionality, and/or other features.

In some examples, computing system 261A may process instances of transaction data to generate generalized or abstracted categories of transactions. For instance, referring again to FIG. 2, abstraction module 277A of computing system 261A accesses data store 279A. Abstraction module 277A retrieves information about transactions performed by customer 110, which may be stored as instances of transaction data 111A, 111B and 111C. Abstraction module 277A may remove from instances of transaction data 111A, 111B and 111C private information, personally-identifiable information, and/or irrelevant information, while retaining demographic information associated with customer 110. This demographic information may be used to generate a transaction signature for a transaction performed by customer 110. In some examples, abstraction module 277A may remove from transaction data 111A information about account numbers, account balances, personally-identifiable information, or other privacy-implicated data. In some examples, abstraction module 277A groups instances of transaction data 111A into bucketed time periods, so that the transactions occurring during a specific time period are collected within the same bucket. Such time periods may correspond to any appropriate time period, including daily, weekly, monthly, quarterly, or annual transaction buckets.

Abstraction module 277A may further abstract the information about the transactions within a specific bucket by identifying a count of the number of transactions in the bucket, and may also identify the type of transaction associated with that count. For instance, in some examples, abstraction module 277A organizes transaction information so that one bucket includes all the credit card transactions for a given month, and the attributes of the bucket may be identified by identifying the type of transaction (i.e., credit card) and a count of the number of transactions in that bucket for that month. Transactions can be categorized in any appropriate manner, and such categories or types of transaction might be credit card transactions, checking account transactions, wire transfers, debit card or other direct transfers from a deposit account, brokerage transactions, cryptocurrency transactions (e.g., Bitcoin), or any other type of transaction. Abstraction module 277A may also associate a size with the transactions within the bucket, which may represent an average, median, or other appropriate metric associated with the collective or aggregate size of the transactions in the bucket. In some examples, abstraction module 377A may create different buckets for a given transaction type and a given time frame. Abstraction module 277A stores such information within data store 279A (e.g., as abstracted transaction data 112A or periodic abstracted transaction data 210).

Computing system 261A may also generate information about a velocity of transactions performed by customer 110. For instance, abstraction module 277A may evaluate the timeframe over which various transactions (as indicated by transaction data 111A, 111B and 111C) were performed on accounts held by customer 110. Abstraction module 277A may determine a velocity attribute based on the timeframes of such transactions. Abstraction module 277A may generate the velocity attribute without including personally-identifiable information, and without including information about specific accounts associated with the velocity of transactions. Abstraction module 277A can store such information within data store 279A as non-periodic abstracted transaction data 220.

Computing system 261A may generate abstracted modeling information that may be shared with computing system 281. For instance, referring again to FIG. 2, abstraction module 377A receives information from modeling module 275A about models developed by modeling module 275A. Such models may have been developed by modeling module 275A to assess risk and/or to make fraud assessments for accounts held by customers at the entity associated with banking terminal 160A. Abstraction module 277A organizes the information about models, which may include outputs or conclusions reached by the models, but could also include parameters, and/or data associated underlying or used to develop such models. Abstraction module 277A modifies the information to remove personally-identifiable information and other information that might be proprietary to the entity associated with banking terminal 160A (e.g., information about number and types of accounts held by customer 110). Abstraction module 277A stores such information within data store 279 as model data 230.

Computing system 261A may share abstracted transaction information with computing system 281. For instance, still referring to the example being described in connection with FIG. 2, abstraction module 277A of computing system 261A causes communication unit 265A to output a signal over a network. Similarly, abstraction module 277B of computing system 261B causes communication unit 265B to output a signal over the network. Communication unit 285 of computing system 281 detects signals over the network and outputs information about the signals to collection module 291. Collection module 291 determines that the signals correspond to abstracted transaction data 112A from computing system 261A and abstracted transaction data 112B from computing system 261B. In some examples, collection module 291 causes computing system 281 to process the data and discard it, thereby helping to preserve the privacy of the data. In other examples, collection module 291 stores at least some aspects of abstracted transaction data 112A and 112B within data store 299.

Computing system 281 may correlate data received from each of banking terminals 160A and 160B. Analysis module 295 of computing system 281 determines that new instances of abstracted transaction data have been received by collection module 291 and/or stored within data store 299. Analysis module 295 accesses abstracted transaction data 112A and 112B and determines that each of abstracted transaction data 112A and 112B relate to transactions performed at accounts held by the same person (i.e., customer 110). Analysis module 295 may make such a determination by correlating a federated ID or other identifier included within each instance of abstracted transaction data 112A and 112B. In some examples, analysis module 295 may similarly correlate other abstracted transaction data received from entities other than the entity associated with banking terminal 160A to identify data associated with customer 110, who may hold accounts at multiple entities.

Computing system 281 may analyze correlated data. For instance, continuing with the example being described with reference to FIG. 2, analysis module 295 analyzes abstracted transaction data 112A and 112B to determine whether any fraudulent, illegitimate, or erroneous transactions have occurred. In some examples, analysis module 295 may assess the size, velocity, and accounts associated with relevant transaction data and use that information to determine whether any fraudulent, illegitimate, and/or erroneous transactions have occurred for accounts associated with customer 110. Analysis module 295 may also assess transaction repletion, transaction type repetition, device type used to perform transactions, etc. In general, analysis module 295 may evaluate transaction data associated with each customer associated with the entity operating banking terminals 160A and 160B.

Modules illustrated in FIG. 2 (e.g., collection module 291, analysis module 295, alert module 297, transaction processing module 271, analysis module 272, modeling module 275, abstraction module 277, and others) and/or illustrated or described elsewhere in this disclosure may perform operations described using software, hardware, firmware, or a mixture of hardware, software, and firmware residing in and/or executing at one or more computing devices. For example, a computing device may execute one or more of such modules with multiple processors or multiple devices. A computing device may execute one or more of such modules as a virtual machine executing on underlying hardware. One or more of such modules may execute as one or more services of an operating system or computing platform. One or more of such modules may execute as one or more executable programs at an application layer of a computing platform. In other examples, functionality provided by a module could be implemented by a dedicated hardware device.

Although certain modules, data stores, components, programs, executables, data items, functional units, and/or other items included within one or more storage devices may be illustrated separately, one or more of such items could be combined and operate as a single module, component, program, executable, data item, or functional unit. For example, one or more modules or data stores may be combined or partially combined so that they operate or provide functionality as a single module. Further, one or more modules may interact with and/or operate in conjunction with one another so that, for example, one module acts as a service or an extension of another module. Also, each module, data store, component, program, executable, data item, functional unit, or other item illustrated within a storage device may include multiple components, sub-components, modules, sub-modules, data stores, and/or other components or modules or data stores not illustrated.

Further, each module, data store, component, program, executable, data item, functional unit, or other item illustrated within a storage device may be implemented in various ways. For example, each module, data store, component, program, executable, data item, functional unit, or other item illustrated within a storage device may be implemented as a downloadable or pre-installed application or “app.” In other examples, each module, data store, component, program, executable, data item, functional unit, or other item illustrated within a storage device may be implemented as part of an operating system executed on a computing device.

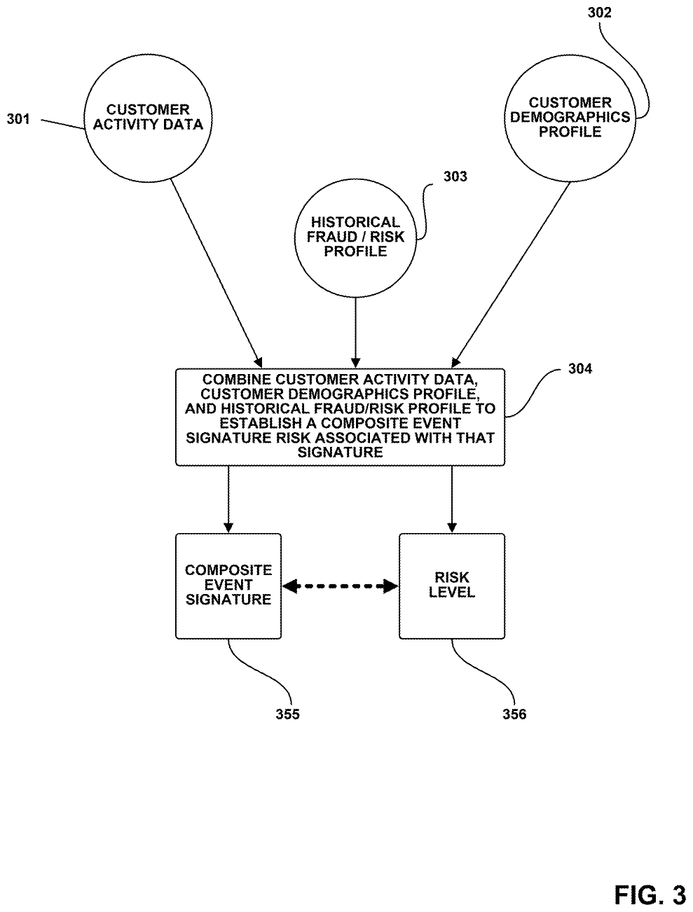

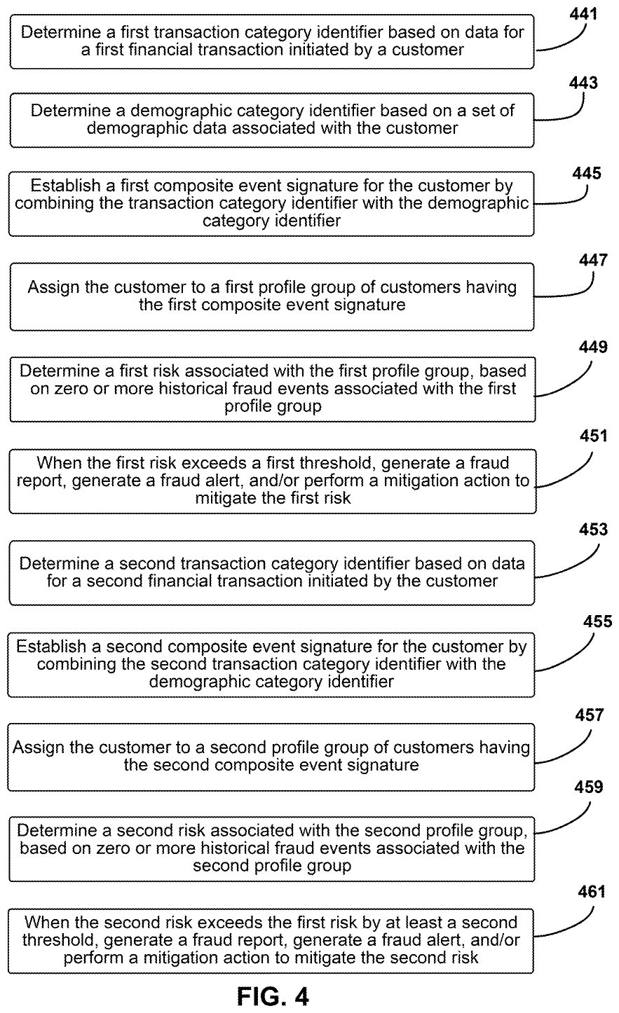

FIG. 3 is a flow diagram illustrating a procedure for preparing composite event signatures from transaction data. Customer activity 301 may include transaction data for one or more events, such as transaction data 111A, 111B, 111C, 121A, 121B, 121C, 131A, 131B, and/or 131C (FIG. 1). At block 304 (FIG. 3), customer activity 301 is combined with a customer demographics profile 302 retrieved from customer demographics database 134 (FIG. 1) and a historical fraud/risk profile 303 (FIG. 3) retrieved from historical risk database 144 (FIG. 1) to establish composite event signature 155 (FIGS. 1 and 3) and a risk level 156 associated with that composite event signature 155. Further details regarding the procedure performed in block 304 are discussed hereinafter with reference to FIGS. 4-17.

FIG. 4 is a flow diagram illustrating an example process for establishing and analyzing composite event signatures obtained from financial transaction data, in accordance with one or more aspects of the present disclosure. In some embodiments, the process of FIG. 4 is performed by one or more of: computing system 161 (FIG. 1), computing system 181, computing system 281 (FIG. 2), computing system 261A, or computing system 261B. At block 441, a first transaction category identifier is determined, based on data for a first financial transaction initiated by a customer. For example, the first financial transaction may correspond to transaction data 131A (FIG. 1), where customer 130 made a credit card purchase at XY Store for $4.14 in San Francisco, CA at 4:12 AM. In this example, transaction data 131A may be categorized using a transaction category identifier indicative of a credit card purchase. In a further example, transaction data 131A can be categorized using data such as a dollar amount of the credit card purchase.

At block 443, a demographic category identifier is determined, based on a set of demographic data associated with the customer. The demographic data for customer 130 may be obtained from customer demographics database 134 (FIG. 1). In some examples, customer demographics database 134 associates each of a plurality of customer identifiers with one or more of a customer's age, birthdate, address, zip code, geographic location, estimated income, profession, place of employment, marital status, number of children, credit score, homeowner versus renter, educational level, employment status, bankruptcy status, time with financial institution 180, bank balance at financial institution 180, or any of various other demographic factors. Demographic category identifier may indicate, for example, an age range for the customer, such as 45-55; a geographic area that includes the customer's residence, such as Midwestern states; a credit score range for the customer, such as 650-700; a time with financial institution of 5 to 7 years; and/or any of various other demographic categories.

At block 445, a first composite event signature is established for the customer by combining the transaction category identifier with demographic category identifier. The customer is assigned to a first profile group of customers having the first composite event signature at block 447. A first risk associated with the first profile group is determined, based on zero or more historical fraud events associated with the first profile group, at block 449. Zero historical fraud events may be indicative of little to no risk.

At block 451, when the first risk exceeds a first threshold, fraud report 158 (FIG. 1) is generated, fraud alert 157 is generated, and/or a mitigation action is performed to mitigate the first risk. Examples of mitigation actions include preventing the first financial transaction, reversing the first financial transaction, sending a warning message to mobile device 132 associated with customer 130, and/or engaging in a waiting period before the first financial transaction is executed. In some examples, computing system 181 may notify customer 130 of potential fraud. For instance, computing system 181 may output a signal over network 125 that causes a notification to be presented to a computing device, such as mobile device 132 used by customer 130. Such a notification may indicate that transactions processing has been limited or stopped for certain accounts held by customer 130. The notification may invite customer 130 to participate in a conversation or other interaction with personnel employed by financial institution 180 to discuss potentially improper transactions. In some examples, computing system 181 may provide fraud alert 157, fraud report 158, or other notification to financial institution 180 that fraud may be occurring on accounts associated with customer 130. Where fraud is detected or suspected, computing system 181 may thus provide information about such an assessment. In some cases, however, computing system 181 determines that any financial transactions being performed on behalf of customer 130 do not show signs of fraud, error, or illegitimacy. In such situations, computing system 181 might not have a reason to generate fraud alert 157 or fraud report 158.

With reference to block 453 of FIG. 4, in some examples, a second transaction category identifier is determined, based on data for a second financial transaction initiated by customer 130 (FIG. 1). The second financial transaction may take place after the first financial transaction. For example, the second financial transaction may correspond to transaction data 131B (FIG. 1), where customer 130 made a debit card purchase at G Eats in San Jose, CA for $35.15 at 5:10 PM. In this example, the second set of transaction category data may indicate a debit card purchase. A second composite event signature is established for customer 130 (FIG. 1) by combining the second transaction category identifier with the demographic category identifier at block 455 (FIG. 4). Customer 130 (FIG. 1) is assigned to a second profile group of customers having the second composite event signature at block 457 (FIG. 4).

At block 459, a second risk associated with the second profile group is determined, based on zero or more historical fraud events associated with the second profile group. Zero historical fraud events may be indicative of little or no risk. At block 461, when the second risk exceeds the first risk by at least a second threshold, fraud report 158 (FIG. 1) is generated, fraud alert 157 is generated, and/or the mitigation action is performed to mitigate the risk. The second threshold can be used to reduce a total number of fraud reports, and/or to only produce a new fraud report if the risk is escalating with subsequent transactions. In other embodiments, the second risk can be compared against the first threshold.

Examples of mitigation actions may include preventing the second financial transaction, reversing the second financial transaction, sending a warning message to a computing device associated with customer 130 over network 125 (such as mobile device 132), and/or engaging in a waiting period before the second financial transaction is executed. In some examples, computing system 181 may notify customer 130 of potential fraud. For instance, computing system 181 may output a signal over network 125 that causes a notification to be presented to a computing device (e.g., mobile device 132) used by customer 130. Such a notification may indicate that transactions processing has been limited or stopped for certain accounts held by customer 130. The notification may invite customer 130 to participate in a conversation or other interaction with personnel employed by financial institution 180 to discuss potentially improper transactions. In some examples, computing system 181 may provide fraud alert 157, fraud report 158, or other notification to financial institution 180 that fraud may be occurring on accounts associated with customer 130. Where fraud is detected or suspected, computing system 181 thus provides information about such an assessment. In some cases, however, computing system 181 determines that any financial transactions being performed on behalf of customer 130 do not show signs of fraud, error, or illegitimacy. In such situations, computing system 181 might not have a reason to generate fraud alert 157 or fraud report 158.

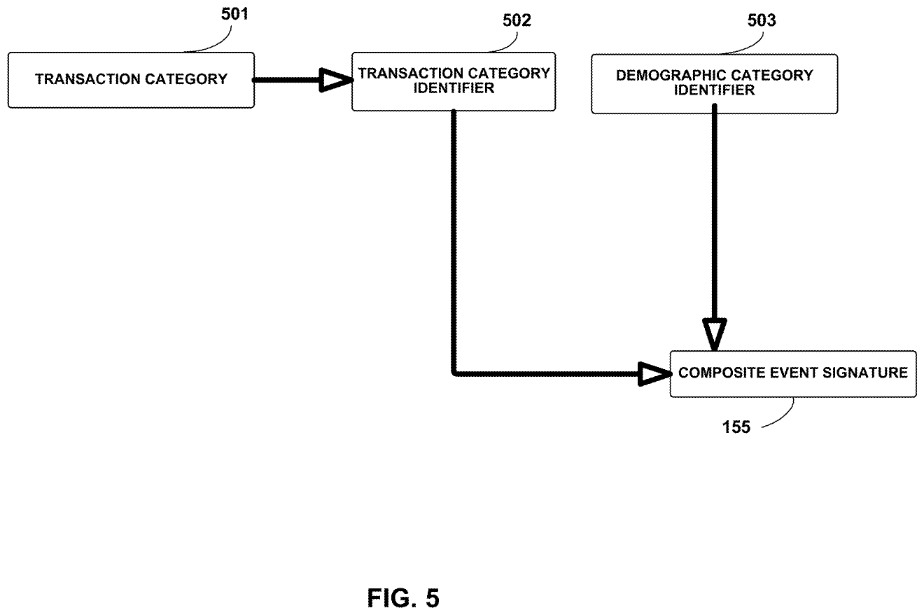

FIG. 5 is a flow diagram illustrating another example process for establishing and analyzing composite event signatures, in accordance with one or more aspects of the present disclosure. A transaction category 501, such as an ATM withdrawal, a cash deposit, a balance verification, or another type of financial transaction, is used to generate a transaction category identifier 502. In some examples, the transaction category identifier 502 is a numeric, alphabetic, or alphanumeric code that uniquely identifies a specific transaction category 501. Likewise, a demographic category identifier 503 is a numeric, alphanumeric, or alphabetic code that uniquely identifies a specific demographic category for a customer, such as age, sex, family size, geographic location, average account balance, and/or various other demographic factors. The transaction category identifier 502 is combined with the demographic category identifier 503 to generate a composite event signature 155. In some examples, this combining can be performed by appending the transaction category identifier 502 to the demographic category identifier 503, or appending the demographic category identifier 503 to the transaction category identifier 502, or hashing the transaction category identifier 502 with the demographic category identifier 503.

The demographic category identifier 503 may be maintained, for example, in the customer demographics database 134 of FIG. 1. The transaction category identifier 502 (FIG. 5) can be layered with a demographic category identifier 503 for customer 110 (FIG. 1). Demographic category identifier 503 may identify one or more demographic categories for customer 110, such as age, time with bank, account balance, location of residence, and/or any of various other demographic categories. For example, customer 110 may be an elderly person of 85 years or older. The transaction category identifier 502 for the three financial transactions may be layered with the demographic category identifier 503 to provide the composite event signature 155.

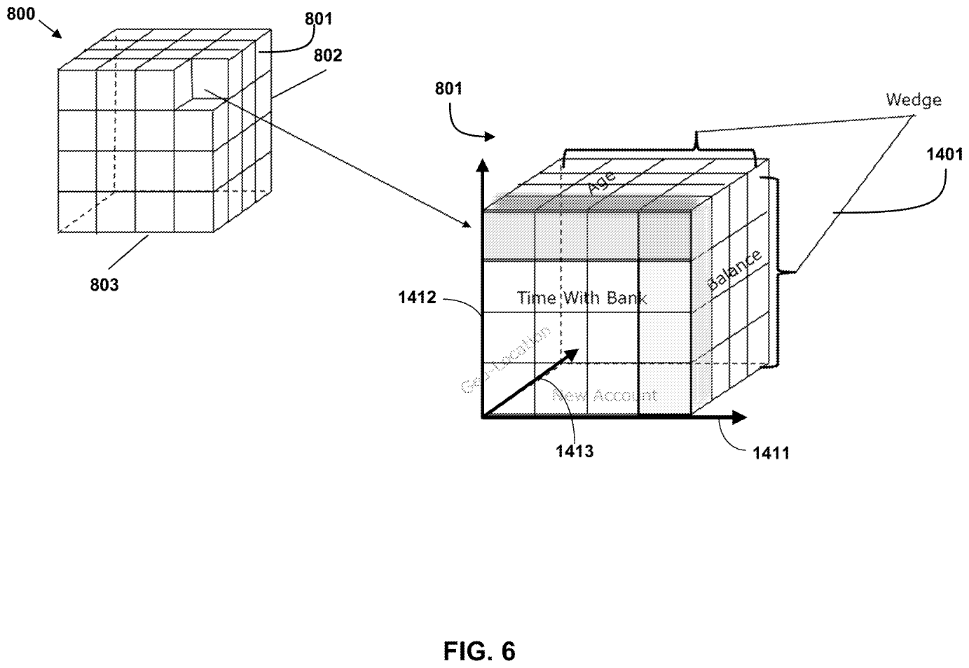

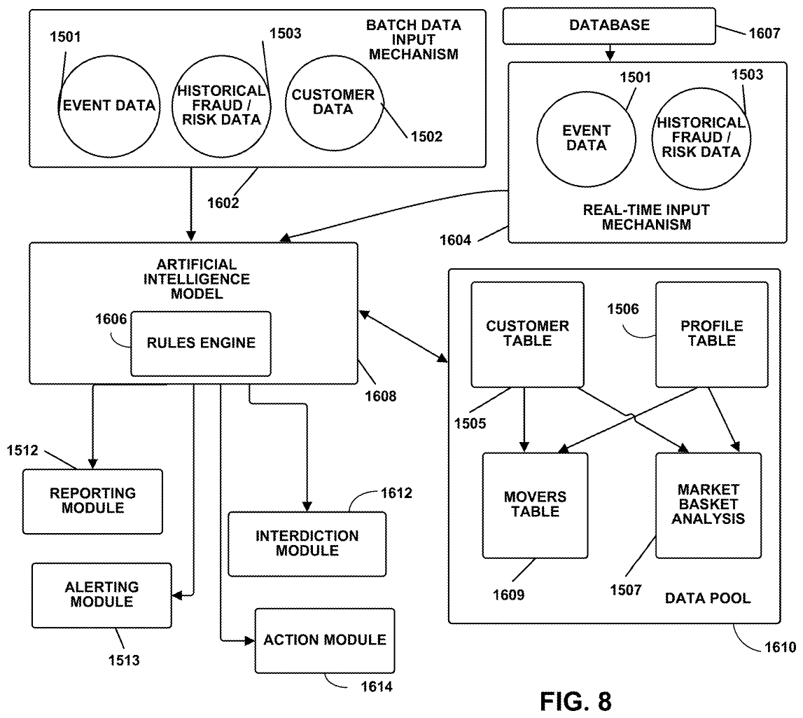

FIG. 6 is a diagrammatic representation showing an illustrative set of customer cubes 800, in accordance with one or more aspects of the present disclosure. In this example, each of a plurality of individual cubes represents a profile group of customers having identical transaction category identifiers. Likewise, each cube represents a specific combination of one or more events. The illustrative set of customer cubes 800 can also be used to represent demographic category identifiers in addition to transaction category identifiers, as will be explained in greater detail hereinafter. A first cube 801 may represent all customers having a first transaction category identifier 502, and identifying a subscriber identity module (SIM) card swap on a mobile device used by a customer, such as mobile device 132 used by customer 130 (FIG. 1), reported via an online channel. A second cube 802 (FIG. 6) can represents all customers having a second transaction category identifier different from the first transaction category identifier 502. For example, the second transaction category identifier can identify adding payee bill pay functionality via the online channel. Thus, the second cube 802 (FIG. 8) may represent all customers who have swapped SIM cards and also added payee bill pay functionality via the online channel. A third cube 803 may represent all customers having a third transaction category identifier. The third transaction category identifier can identify a card-free ATM request via the phone channel. Thus, the third cube 803 (FIG. 6) may represent all customers who have initiated a card-free ATM request via the phone channel and a one-time passcode request via the online channel.

In one example, the set of customer cubes 800 can be based on 63 events via 4 customer access channels including the online channel, a store channel, an ATM channel, and a phone channel or a customer contact center. Given 63 events and 4 customer access channels, the set of customer cubes 800 can be used to represent 18,009,337,500 potential transaction combinations or individual cubes. In some examples, a high percentage of individual cubes (95% in the present case) is associated with a very low, negligible, or zero risk of fraud, while a small subset of individual cubes is associated with a more significant risk of fraud. The technical advantages, benefits, improvements, and practical applications of the invention include identifying one or more fraudulent transactions by selectively combining customer demographic data with one or more transaction categories to generate composite event signatures, analyzing the composite event signatures, and generating an alarm in response to the identified one or more fraudulent transactions. The composite event signatures represent a very high volume of transactions with many thousands of potential permutations across multiple customer demographics and transaction categories. In accordance with some embodiments, the transactions are digitized and categorized in order to analyze risk and fraud factors associated with customers in specific categories. The system analyzes the digitized and categorized data to identify patterns in how fraudsters interact with a financial institution in order to gain unauthorized access to third-party accounts.

As previously mentioned, each of a plurality of individual cubes shown in FIG. 6 (such as the first cube 801) represents a profile group of customers having identical transaction category identifiers. Likewise, each cube represents a specific combination of one or more events. First cube 801 may be expanded to include a plurality of wedges, such as a wedge 1401, where each wedge represents a specific demographic category identifier 503 (FIG. 5). For example, wedge 1401 (FIG. 6) may represent a first demographic category identifier pertaining to customers having a specific range of account balances. Wedge 1401 may include customers of all ages who have been with financial institution 180 (FIG. 1) for any duration of time. Accordingly, a first axis 1411 of first cube 801 (FIG. 6) may represent each of a plurality of ranges of account balances, a second axis 1412 of first cube 801 may represent each of a plurality of age ranges of customers, and a third axis 1413 of first cube 801 may represent each of a plurality of ranges specifying a duration of time customers have remained with financial institution 180 (FIG. 1). In some examples, each of the six faces of first cube 801 may represent one of the six demographic categories included in the identifier.

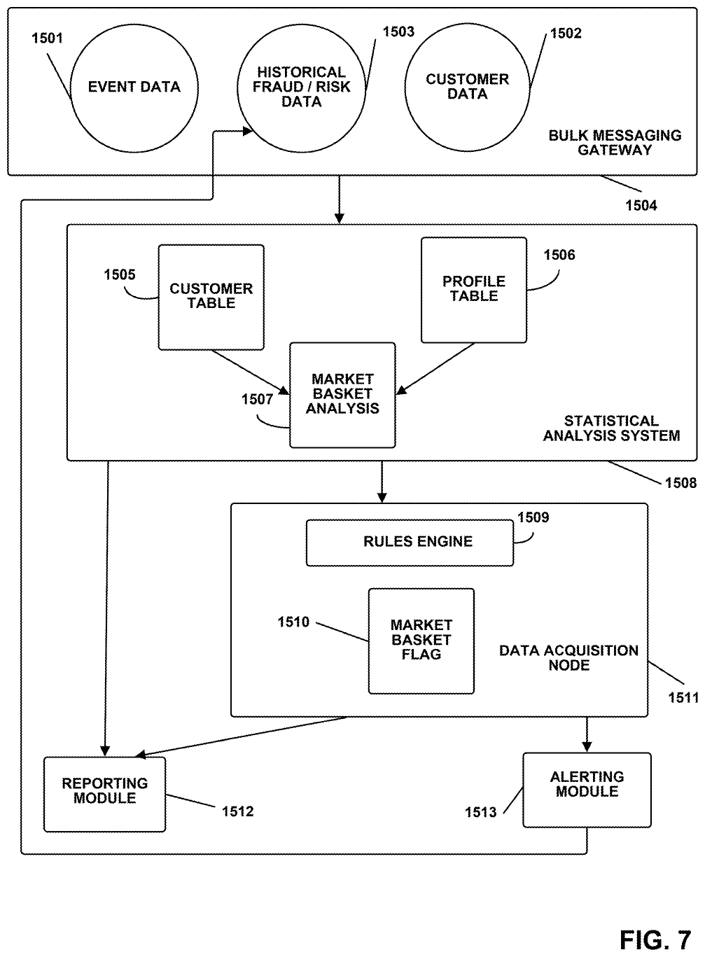

FIG. 7 is a data flow diagram showing an illustrative procedure for processing data to generate alerts and reports, in accordance with one or more aspects of the present disclosure. A bulk messaging gateway 1504 receives event data 1501 for one or more financial transactions, along with customer data 1502 including one or more customer demographics, and historical fraud/risk data 1503. Historical fraud/risk data 1503 may associate each of a plurality of event parameters and demographic parameters with an associated level of risk. In some embodiments, bulk messaging gateway 1504 is implemented by one or more of input devices 266A (FIG. 2) of computing system 261A, input devices 266B of computing system 261B, or input devices 286 of computing system 281.

A statistical analysis system 1508 (FIG. 7) organizes and processes data gathered by bulk messaging gateway 1504 to generate a customer table 1505 associating each of a plurality of customer identifiers with one or more corresponding transactions, and a profile table 1506 associating each of a plurality of customer identifiers with one or more corresponding demographic profiles. Statistical analysis system 1508 generates a market basket analysis 1507 based on customer table 1505 and profile table 1506. Market basket analysis 1507 categorizes customer transactions into one of a plurality of baskets, based on the customer table 1505 and the profile table 1506. In some embodiments, statistical analysis system 1508 is implemented by one or more of analysis module 273A (FIG. 2) of computing system 261A, analysis module 273B of computing system 261B, or analysis module 295 of computing system 281.

A data acquisition node 1511 (FIG. 7) includes a rules engine 1509 configured to apply a rule set to market basket analysis 1507 to generate a market basket flag 1510. Market basket flag 1510 identifies one or more categories of market based analysis 1507 that are associated with a high risk of fraud. In some embodiments, data acquisition node 1511 is implemented by one or more of modeling module 275A (FIG. 2) of computing system 261A, or modeling module 275B of computing system 261B.

A reporting module 1512 (FIG. 7), operatively coupled to data acquisition node 1511, is configured to generate one or more reports in response to historical fraud/risk data 1503 indicating a risk above a threshold that is associated with received event data 1503 and/or received customer data 1502. An alerting module 1513, operatively coupled to data acquisition node 1511, is configured to generate one or more alerts in response to historical fraud/risk data 1503 indicating a risk above the threshold that is associated with received event data 1501 and/or received customer data 1502. The alerting module 1513 may provide feedback and/or updates to historical fraud/risk data 1503 of bulk messaging gateway 1504. In some embodiments, reporting module 1512 and/or alerting module 1513 are implemented by one or more of output devices 267A (FIG. 2) of computing system 261A, output devices 267B of computing system 261B, or output devices 287 of computing system 281.

FIG. 8 is a data flow diagram showing an illustrative procedure for processing data to perform one or more of generating an alert, producing a report, performing an interdiction, or performing an action, in accordance with one or more aspects of the present disclosure. Event data 1501 is received for one or more financial transactions, along with customer data 1502 including one or more customer demographics, and historical fraud/risk data 1503. Historical fraud/risk data 1503 may associate each of a plurality of event parameters and demographic parameters with an associated level of risk. Event data 1501, customer data 1502 and historical fraud/risk data 1503 are processed by a batch data input mechanism 1602 which, for example, may process incoming data multiple times a day. In some embodiments, batch data input mechanism 1602 is implemented by one or more of input devices 266A (FIG. 2) of computing system 261A, input devices 266B of computing system 261B, or input devices 286 of computing system 281.

A real-time input mechanism 1604 (FIG. 8) accepts event data 1501 and historical fraud/risk data 1503. In some embodiments, real-time input mechanism 1604 is implemented by one or more of input devices 266A (FIG. 2) of computing system 261A, input devices 266B of computing system 261B, or input devices 286 of computing system 281. Real-time input mechanism 1604 may receive event data 1501, for example, from a database 1607. Data from database 1607 may flow from financial institution 180 (FIG. 1) through network 125 to real-time input mechanism 1604. Real-time input mechanism 1604 may append data to customer table 1505.

Batch data input mechanism 1602 and real-time input mechanism 1604 are operatively coupled to an artificial intelligence model 1608. In some embodiments, artificial intelligence model 1608 is configured with a rules engine 1606. Artificial intelligence model 1608 may process event data 1501, customer data 1502 and historical fraud/risk data 1503 to generate profile table 1506, customer table 1505, market basket analysis 1507, and a movers table 1609. Artificial intelligence model 1608 may instruct reporting module 1512 to generate one or more reports in response to historical fraud/risk data 1503 indicating a risk above a threshold that is associated with received event data 1501 and/or received customer data 1502. Artificial intelligence model 1608 may download profile table 1506, customer table 1505, market basket analysis 1507 and movers table 1609 to a data pool 1610. In some examples, data pool 1610 can be implemented using one or more data storage drives, a data center, a computer network, one or more virtual machines, or any of various combinations thereof.

Real-time input mechanism 1604 may apply historical fraud/risk data 1503 to event data 1501 to generate a processed data stream. The data stream can be downloaded to the artificial intelligence model 1608. Rules engine 1606 is configured to apply one or more rules to the data stream to perform one or more of: generating a report for reporting module 1512, generating an alert for alerting module 1513, instructing an interdiction module 1612 to generate an interdiction message identifying a risky target event, and/or instructing an action module 1614 to initiate an action in response to the risky target event, such as delaying or preventing a customer transaction, or triggering a verification procedure for the customer. In some embodiments, reporting module 1512, interdiction module 1612, alerting module 1513, and/or action module 1614 are implemented by one or more of output devices 267A (FIG. 2) of computing system 261A, output devices 267B of computing system 261B, or output devices 287 of computing system 281.

In some embodiments, artificial intelligence model 1608 (FIG. 8) is implemented by analysis module 295 of computing system 281, modeling module 275A (FIG. 2) of computing system 261A, and/or modeling module 275B of computing system 261B. Artificial intelligence model 1608 (FIG. 8) may perform modeling functions, which may include training, evaluating, and/or applying models (e.g., machine learning models) to evaluate transactions, customer behavior, or other aspects of customer activity.

In some examples, artificial intelligence model 1608 may train and/or continually retrain a machine learning model to make fraud and other assessments for transactions occurring on any of the accounts at the entity associated with banking terminal 160A (FIG. 2). For instance, modeling module 275A may develop a model of behavior associated with one or more of customers 110, 120, and/or 130. Such a model may enable computing system 261A (or analysis module 273A) to determine when transactions might be unusual, erroneous, fraudulent, or otherwise improper.

In some examples, artificial intelligence model 1608 (FIG. 8) may determine whether the transaction data is consistent with past spending and/or financial activity practices associated with a given customer (e.g., any of customers 110, 120, and/or 130 of FIGS. 1 and 2). In other words, analysis module 295 (FIG. 2) may determine whether transactions performed by a specific customer is considered “normal” or is in one or more ways inconsistent with prior activities performed by each such customer. For example, analysis module 295 may apply a model to abstracted transaction data 112A and abstracted transaction data 112B to make an assessment of accounts held by customer 110 at the entity associated with banking terminals 160A and 160B. In some examples, analysis module 295 may generate a score for customer 110 (or other customers) that quantifies the activity of such customers relative to normal.

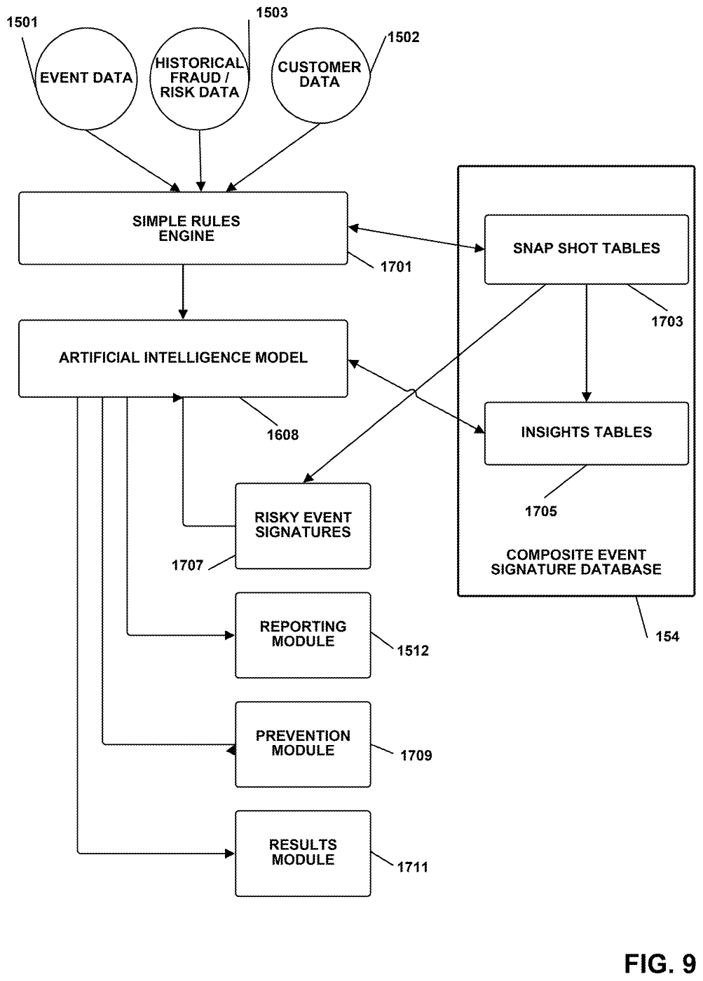

FIG. 9 is a data flow diagram showing an illustrative procedure for processing data to perform a fraud prevention action comprising one or more of generating an alert, producing a report, performing an interdiction, or performing an action, in accordance with one or more aspects of the present disclosure. A simple rules engine 1701 receives event data 1501 for one or more financial transactions, along with customer data 1502 including one or more customer demographics, and historical fraud/risk data 1503. In some embodiments, simple rules engine 1701 is implemented by analysis module 295 of computing system 281, modeling module 275A (FIG. 2) of computing system 261A, and/or modeling module 275B of computing system 261B. Historical fraud/risk data 1503 (FIG. 17) may associate each of a plurality of event parameters and demographic parameters with an associated level of risk.

Incoming event data 1501, customer data 1502, and historical fraud/risk data 1503 is saved to composite event signature database 154 (FIGS. 1 and 9). Composite event signature database 154 may include one or more snap shot tables 1703 populated and administered by simple rules engine 1701. Simple rules engine 1701 may be configured with one or more of: a set of simple rules, a screening mechanism for identifying false positives by signature, an analysis mechanism for performing a market basket analysis, and/or demographic layers.

Simple rules engine 1701 is operatively coupled to artificial intelligence model 1608. Artificial intelligence model 1608 may be configured with a manager functionality that implements any of: complex rules, artificial intelligence, one or more insight tables, a test and learn procedure, text analytics, a movers and shakers analysis, an identification of one or more new threat vectors, auto-disposition, and/or formulation of treatment recommendations. Reporting module 1512, operatively coupled to composite event signature database 154 and artificial intelligence model 1608, may be configured to generate one or more shakers and movers reports, and/or reports associated with new threat vectors. One or more risky event signatures 1707 from snap shot tables 1703 may be used as adaptive feedback by artificial intelligence model 1608.

Artificial intelligence model 1608 may be operatively coupled to a prevention module 1709 configured for identifying one or more fraud prevention measures, and for downloading the fraud prevention measures to a results module 1711. Results module 1711 may be configured to generate a worked false positive report by composite event signature 155 (FIG. 1), and/or configured to generate a shakers and movers report. In some embodiments, reporting module 1512 (FIG. 9), prevention module 1709, and/or results module 1711 are implemented by one or more of output devices 267A (FIG. 2) of computing system 261A, output devices 267B of computing system 261B, or output devices 287 of computing system 281.

Although certain modules, data stores, components, programs, executables, data items, functional units, and/or other items included within one or more storage devices may be illustrated separately, one or more of such items could be combined and operate as a single module, component, program, executable, data item, or functional unit. For example, one or more modules or data stores may be combined or partially combined so that they operate or provide functionality as a single module. Further, one or more modules may interact with and/or operate in conjunction with one another so that, for example, one module acts as a service or an extension of another module. Also, each module, data store, component, program, executable, data item, functional unit, or other item illustrated within a storage device may include multiple components, sub-components, modules, sub-modules, data stores, and/or other components or modules or data stores not illustrated.

Further, each module, data store, component, program, executable, data item, functional unit, or other item illustrated within a storage device may be implemented in various ways. For example, each module, data store, component, program, executable, data item, functional unit, or other item illustrated within a storage device may be implemented as a downloadable or pre-installed application or “app.” In other examples, each module, data store, component, program, executable, data item, functional unit, or other item illustrated within a storage device may be implemented as part of an operating system executed on a computing device.

For processes, apparatuses, and other examples or illustrations described herein, including in any flowcharts or flow diagrams, certain operations, acts, steps, or events included in any of the techniques described herein can be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Further certain operations, acts, steps, or events may be performed automatically even if not specifically identified as being performed automatically. Also, certain operations, acts, steps, or events described as being performed automatically may be alternatively not performed automatically, but rather, such operations, acts, steps, or events may be, in some examples, performed in response to input or another event.

For ease of illustration, only a limited number of devices (e.g., computing system 161, computing systems 181) are shown within the Figures and/or in other illustrations referenced herein. However, techniques in accordance with one or more aspects of the present disclosure may be performed with many more of such systems, components, devices, modules, and/or other items, and collective references to such systems, components, devices, modules, and/or other items may represent any number of such systems, components, devices, modules, and/or other items.

The Figures included herein each illustrate at least one example implementation of an aspect of this disclosure. The scope of this disclosure is not, however, limited to such implementations. Accordingly, other example or alternative implementations of systems, methods or techniques described herein, beyond those illustrated in the Figures, may be appropriate in other instances. Such implementations may include a subset of the devices and/or components included in the Figures and/or may include additional devices and/or components not shown in the Figures.

The detailed description set forth above is intended as a description of various configurations and is not intended to represent the only configurations in which the concepts described herein may be practiced. The detailed description includes specific details for the purpose of providing a sufficient understanding of the various concepts. However, these concepts may be practiced without these specific details. In some instances, well-known structures and components are shown in block diagram form in the referenced figures in order to avoid obscuring such concepts.

Accordingly, although one or more implementations of various systems, devices, and/or components may be described with reference to specific Figures, such systems, devices, and/or components may be implemented in a number of different ways. For instance, one or more devices illustrated in the Figures herein as separate devices may alternatively be implemented as a single device; one or more components illustrated as separate components may alternatively be implemented as a single component. Also, in some examples, one or more devices illustrated in the Figures herein as a single device may alternatively be implemented as multiple devices; one or more components illustrated as a single component may alternatively be implemented as multiple components. Each of such multiple devices and/or components may be directly coupled via wired or wireless communication and/or remotely coupled via one or more networks. Also, one or more devices or components that may be illustrated in various Figures herein may alternatively be implemented as part of another device or component not shown in such Figures. In this and other ways, some of the functions described herein may be performed via distributed processing by two or more devices or components.

Further, certain operations, techniques, features, and/or functions may be described herein as being performed by specific components, devices, and/or modules. In other examples, such operations, techniques, features, and/or functions may be performed by different components, devices, or modules. Accordingly, some operations, techniques, features, and/or functions that may be described herein as being attributed to one or more components, devices, or modules may, in other examples, be attributed to other components, devices, and/or modules, even if not specifically described herein in such a manner.

Although specific advantages have been identified in connection with descriptions of some examples, various other examples may include some, none, or all of the enumerated advantages. Other advantages, technical or otherwise, may become apparent to one of ordinary skill in the art from the present disclosure. Further, although specific examples have been disclosed herein, aspects of this disclosure may be implemented using any number of techniques, whether currently known or not, and accordingly, the present disclosure is not limited to the examples specifically described and/or illustrated in this disclosure.

In one or more examples, the functions described may be implemented in hardware, software, firmware, or any combination thereof. If implemented in software, the functions may be stored, as one or more instructions or code, on and/or transmitted over a computer-readable medium and executed by a hardware-based processing unit. Computer-readable media may include computer-readable storage media, which corresponds to a tangible medium such as data storage media, or communication media including any medium that facilitates transfer of a computer program from one place to another (e.g., pursuant to a communication protocol). In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include RAM, ROM, EEPROM, or optical disk storage, magnetic disk storage, or other magnetic storage devices, flash memory, or any other medium that can be used to store desired program code in the form of instructions or data structures and that can be accessed by a computer. Also, any connection may properly be termed a computer-readable medium. For example, if instructions are transmitted from a website, server, or other remote source using a wired (e.g., coaxial cable, fiber optic cable, twisted pair) or wireless (e.g., infrared, radio, and microwave) connection, then the wired or wireless connection is included in the definition of medium. It should be understood, however, that computer-readable storage media and data storage media do not include connections, carrier waves, signals, or other transient media, but are instead directed to non-transient, tangible storage media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the terms “processor” or “processing circuitry” as used herein may each refer to any of the foregoing structure or any other structure suitable for implementation of the techniques described. In addition, in some examples, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, a mobile or non-mobile computing device, a wearable or non-wearable computing device, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperating hardware units, including one or more processors as described above, in conjunction with suitable software and/or firmware.

What is claimed is:

1. A method comprising:
determining a first transaction category identifier based on data for a first financial transaction initiated by a customer;
determining a demographic category identifier based on a set of demographic data associated with the customer;
establishing a first composite event signature for the customer by combining the transaction category identifier with the demographic category identifier;
assigning the customer to a first profile group of customers having the first composite event signature;
determining a first risk associated with the first profile group, based on zero or more historical fraud events associated with the first profile group; and
when the first risk exceeds a first threshold, at least one of generating a first fraud report, generating a first fraud alert, or performing a first mitigation action to mitigate the first risk.

2. The method of claim 1, further comprising:
determining a second transaction category identifier based on data for a second financial transaction initiated by the customer;
establishing a second composite event signature for the customer by combining the second transaction category identifier with the demographic category identifier;
assigning the customer to a second profile group of customers having the second composite event signature;
determining a second risk associated with the second profile group, based on zero or more historical fraud events associated with the second profile group; and
when the second risk exceeds the first risk by at least a second threshold, at least one of generating a second fraud report, generating a second fraud alert, or performing the mitigation action to mitigate the second risk.

3. The method of claim 1, further comprising sending the first fraud alert to one or more of: a mobile device associated with the customer or a computing device associated with a financial institution.

4. The method of claim 1, wherein the first fraud report comprises at least one of a textual report, a graphical report, or a displayed report forwarded to one or more of: a mobile device associated with the customer or a computing device associated with a financial institution.

5. The method of claim 1, wherein the first mitigation action comprises one or more of: not completing the first financial transaction, reversing the first financial transaction, or providing a message, to a mobile device associated with the customer, asking the customer to confirm the transaction.

6. The method of claim 1, wherein the second financial transaction occurs after the first financial transaction.

7. The method of claim 1, further comprising determining the transaction category identifier by determining a channel used to perform the transaction.

8. The method of claim 7, wherein the channel comprises one or more of an online portal, a store, a phone, or an automated teller machine (ATM).

9. The method of claim 1, further comprising determining a false positive probability for the first risk.

10. A system comprising: a memory and one or more processors in communication with the memory, t, the one or more processors configured to:
determine a first transaction category identifier based on data for a first financial transaction initiated by a customer;
determine a demographic category identifier based on a set of demographic data associated with the customer;
establish a first composite event signature for the customer by combining the transaction category identifier with the demographic category identifier;
assign the customer to a first profile group of customers having the first composite event signature;
determine a first risk associated with the first profile group, based on zero or more historical fraud events associated with the first profile group; and
when the first risk exceeds a first threshold, at least one of generate a first fraud report, generate a first fraud alert, or perform a first mitigation action to mitigate the first risk.

11. The system of claim 10, wherein the one or more processors are further configured to:
determine a second transaction category identifier based on data for a second financial transaction initiated by the customer;
combine the second transaction category identifier with the demographic category identifier to establish a second composite event signature for the customer;
assign the customer to a second profile group of customers having the second composite event signature;
determine a second risk associated with the second profile group, based on zero or more historical fraud events associated with the second profile group; and
when the second risk exceeds the first risk by at least a second threshold, at least one of generate a second fraud report, generate a second fraud alert, or perform the mitigation action to mitigate the second risk.

12. The system of claim 10, further comprising an interface to a network; wherein the one or more processors are further configured to send the first fraud alert over the network to one or more of: a mobile device associated with the customer or a computing device associated with a financial institution.

13. The system of claim 10, wherein the first fraud report comprises at least one of a textual report or a displayed report forwarded to one or more of: a mobile device associated with the customer or a computing device associated with a financial institution.

14. The system of claim 10, wherein the first mitigation action comprises one or more of: not completing the first financial transaction, reversing the first financial transaction, or providing a message, to a mobile device associated with the customer, asking the customer to confirm the transaction.

15. The system of claim 10, wherein the one or more processors are further configured to determine the transaction category identifier based on a channel used to perform the transaction.

16. The system of claim 15, wherein the channel comprises one or more of an online portal, a store, a phone, or an automated teller machine (ATM).

17. The system of claim 10, wherein the one or more processors are further configured to determine a false positive probability for the first risk.

18. A non-transitory computer-readable media having computer-executable instructions embodied therein that, when executed by one or more processors of a computing system, cause the computing system to perform operations comprising:
determining a first transaction category identifier based on data for a first financial transaction initiated by a customer;
determining a demographic category identifier based on a set of demographic data associated with the customer;
establishing a first composite event signature for the customer by combining the transaction category identifier with the demographic category identifier;
assigning the customer to a first profile group of customers having the first composite event signature;
determining a first risk associated with the first profile group, based on zero or more historical fraud events associated with the first profile group; and
when the first risk exceeds a first threshold, at least one of generating a first fraud report, generating a first fraud alert, or performing a first mitigation action to mitigate the first risk.

19. The non-transitory computer-readable medium of claim 18, further comprising instructions for:
determining a second transaction category identifier based on data for a second financial transaction initiated by the customer;
establishing a second composite event signature for the customer by combining the second transaction category identifier with the demographic category identifier;
assigning the customer to a second profile group of customers having the second composite event signature;
determining a second risk associated with the second profile group, based on zero or more historical fraud events associated with the second profile group; and
when the second risk exceeds the first risk by at least a second threshold, at least one of generating a second fraud report, generating a second fraud alert, or performing the mitigation action to mitigate the second risk.

20. The non-transitory computer-readable medium of claim 18, further comprising instructions for sending the first fraud alert to one or more of: a mobile device associated with the customer or a computing device associated with a financial institution.
